(19) United States
(12) Patent Application Publication
(10) Pub. No.: US 2026/0104979 A1
(43) Pub. Date: Apr. 16, 2026

(54) PLATFORM ASSISTED OS/WORKLOAD AGNOSTIC OPTIMAL MEMORY TIERING ACROSS NODES FOR DISTRIBUTED APPLICATIONS

(71) Applicant: Dell Products L.P., Round Rock, TX (US)

(72) Inventors: Krishnaprasad Koladi, Bangalore (IN); Vinod Parackal Saby, Bangalore (IN)

(21) Appl. No.: 18/914,824

(22) Filed: Oct. 14, 2024

(51) Int. Cl. G06F 11/34; G06F 9/50

(52) U.S. Cl. CPC G06F 11/3433; G06F 9/5083; G06F 11/3495

(57) ABSTRACT

A method for generating a dynamic memory tiering profile (MTP) for a workload. The method includes obtaining workload requirements based on the workload. The method also includes receiving a standard MTP for the workload. Further, the method includes retrieving memory characteristic information of a plurality of nodes in a cluster. In addition, the method includes identifying a target node. Moreover, the method includes deploying the workload with the standard MTP on the target node. Also, the method includes measuring a first performance metric of the target node. Further, the method includes setting a first performance baseline based on the first performance metric of the target node. Also, the method includes making a determination that the performance of the target node is below the performance baseline. Also, the method includes modifying, using the performance of the target node, the standard MTP to generate a dynamic MTP.

### BACKGROUND

Memory tiering models assist in creating memory tiering profiles (MTP) for workloads. These workloads are then assigned to a node in a cluster. However, traditional memory tiering models do not achieve uniform performance across nodes in the cluster.

### SUMMARY

In general, described herein relate to a method for generating a dynamic memory tiering profile (MTP) for a workload. The method includes obtaining workload requirements based on the workload. The method also includes receiving a standard MTP for the workload. Further, the method includes retrieving, from a distributed app performance manager agent (DAPMA), memory characteristic information of a plurality of nodes in a cluster. In addition, the method includes identifying, based on the memory characteristic information, a target node. Moreover, the method includes deploying the workload with the standard MTP on the target node. Also, the method includes measuring a first performance metric of the target node. Further, the method includes setting a first performance baseline based on the first performance metric of the target node. The method also includes monitoring a performance of the target node. In addition, the method include making a determination that the performance of the target node is below the performance baseline. Also, the method includes modifying, using the performance of the target node, the standard MTP to generate a dynamic MTP.

In general, embodiments described herein relate to a non-transitory computer readable medium including computer readable program code, which when executed by a computer processor enables the computer processor to perform a method for generating a dynamic memory tiering profile (MTP) for a workload. The method includes obtaining workload requirements based on the workload. The method also includes receiving a standard MTP for the workload. Further, the method includes retrieving, from a distributed app performance manager agent (DAPMA), memory characteristic information of a plurality of nodes in a cluster. In addition, the method includes identifying, based on the memory characteristic information, a target node. Moreover, the method includes deploying the workload with the standard MTP on the target node. Also, the method includes measuring a first performance metric of the target node. Further, the method includes setting a first performance baseline based on the first performance metric of the target node. The method also includes monitoring a performance of the target node. In addition, the method include making a determination that the performance of the target node is below the performance baseline. Also, the method includes modifying, using the performance of the target node, the standard MTP to generate a dynamic MTP.

In general, embodiments described herein relate to a system for generating a dynamic memory tiering profile (MTP) for a workload. The method includes obtaining workload requirements based on the workload. The method also includes receiving a standard MTP for the workload. Further, the method includes retrieving, from a distributed app performance manager agent (DAPMA), memory characteristic information of a plurality of nodes in a cluster. In addition, the method includes identifying, based on the memory characteristic information, a target node. Moreover, the method includes deploying the workload with the standard MTP on the target node. Also, the method includes measuring a first performance metric of the target node. Further, the method includes setting a first performance baseline based on the first performance metric of the target node. The method also includes monitoring a performance of the target node. In addition, the method include making a determination that the performance of the target node is below the performance baseline. Also, the method includes modifying, using the performance of the target node, the standard MTP to generate a dynamic MTP.

Other aspects of the embodiments disclosed herein will be apparent from the following description and the appended claims.

### BRIEF DESCRIPTION OF DRAWINGS

Certain embodiments of the disclosure will be described with reference to the accompanying drawings. However, the accompany drawings illustrate only certain aspects or implementations of the disclosure by way of example and are not meant to limit the scope of the claims.

FIG. 1 shows a diagram of a cluster environment in accordance with one or more embodiments.

FIG. 2 shows a flowchart of a method for generating standard memory MTPs in accordance with one or more embodiments of the invention.

FIG. 3.1 shows a flowchart of a method for deploying workloads with a standard MTP to a target node in accordance with one or more embodiments of the invention.

FIG. 3.2 shows a flowchart of a method for modifying an MTP associated with a workload and target node in accordance with one or more embodiments of the invention.

FIG. 4 shows a flowchart of a method for assigning the same MTP of a parent workload to all child workloads in accordance with one or more embodiments of the invention.

FIG. 5 shows a flowchart of a method for deploying a parent workload from an unavailable root node to a second root node in accordance with one or more embodiments of the invention.

FIG. 6 shows a flowchart of a method for deploying a parent workload from an unavailable root node to a second root node in accordance with one or more embodiments of the invention.

FIG. 7 shows a diagram of a parent and child workload system in accordance with one or more embodiments of the invention.

FIG. 8 shows a diagram of a parent and child workload system with an unavailable node in accordance with one or more embodiments of the invention.

FIG. 9 shows a diagram of a parent and child workload system with an unavailable node in accordance with one or more embodiments of the invention.

FIG. 10 shows a computing system in accordance with one or more embodiments of the invention.

### DETAILED DESCRIPTION

Currently, there are two memory tiering models available. The first model is commonly referred to as “Firmware First”, where the system basic input output system (BIOS) manages the tiering of memory when creating MTPs. The second model is commonly referred to as “Software Defined Memory Tiering”, where certain memory attributes are considered when creating MTPs. However, each of these conventional memory tiering models are not able to fully optimize memory tiering for distributed applications. Specifically, the “Firmware First” model does not take the operating system (OS), the applications, and/or how the applications are scheduled to execute on the system in to account when creating the MTPs. Further, the “Software Defined Memory Tiering” model provides solutions that are not standard based solutions. Rather, the conventional memory tiering models are dependent upon vendor implementations, which results in inconsistent approaches to memory tiering.

Further, a consistent profile-based memory tiering model is unavailable at the virtual machine (VM)/container level. Moreover, all the conventional memory tiering models are directed at a system level, but not at the process/application level. Finally, performance consistency in memory tiering models across nodes has not been achieved with any of the above-mentioned mechanisms.

The limitations of the traditional approaches to generating memory tiering models and achieving uniform performance across a cluster of nodes restrict the flexibility and usability of current memory tiering models in real-world applications. For at least the reasons discussed above, a fundamentally different approach is needed to address these challenges and improve the efficiency of memory tiering models. Embodiments of the invention relate to generating a dynamic memory tiering profile (MTP) for a workload. As a result of the processes discussed below, one or more embodiments disclosed herein advantageously ensure an MTP based on real-time characteristics, and a system that achieves uniform performance across nodes in a cluster.

Specific embodiments will now be described with reference to the accompanying figures.

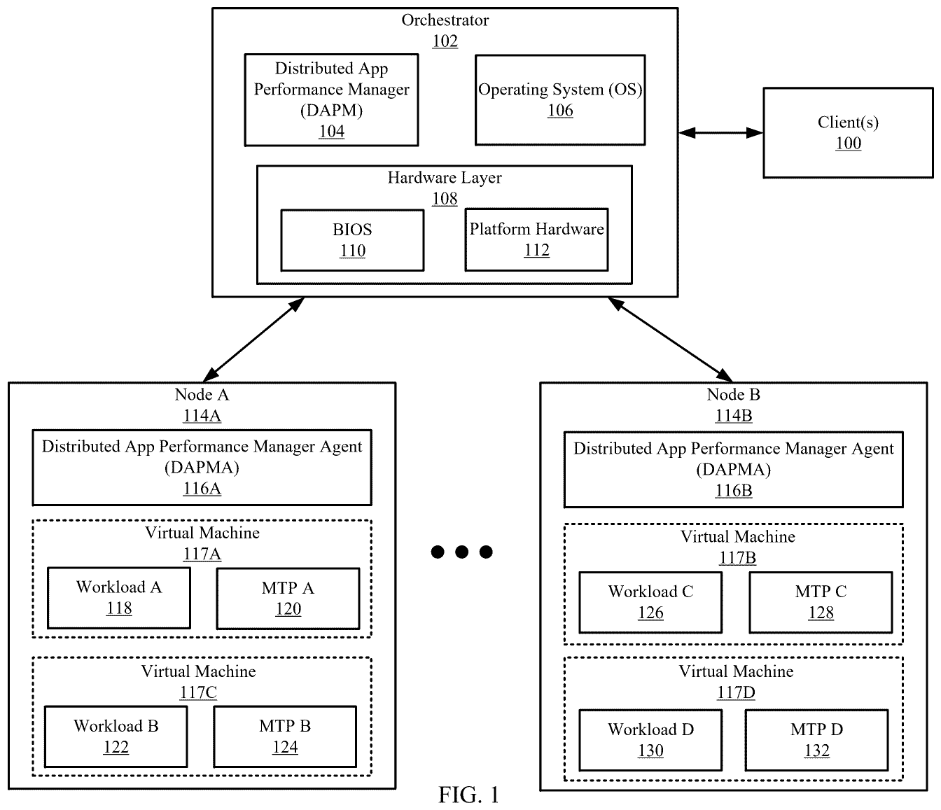

FIG. 1 shows a system in accordance with one or more embodiments. The system may include any number of clients (100), an orchestrator (102), and a plurality of nodes (e.g., 114A-114B). For example, the system may include two nodes (e.g., 114A and 114B) that communicate through an internal network or by other means. The system may include additional, fewer, and/or different components without departing from the scope of the invention. Each component may be operably/operatively connected to any of the other components via any combination of wired and/or wireless connections. Each of these system components is described below.

A node (e.g., 114A-114B) may include a distributed app performance manager agent, or DAPMA (e.g., 116A-116B) (described below), and any number of virtual machines. The node (e.g., 114A-114B) may alternatively include any number of containers (not shown). In one or more embodiments, each of the virtual machines or containers may host any number of workloads. Further, each of the virtual machines or containers may also have an associated MTP. Execution of the workloads may be performed by the containers or virtual machines.

As a non-limiting example, Node A (114A) may have Workload A (118) with an associated MTP A (120), where Workload A (118) is executing in Virtual Machine (117A). Additionally, Node A (114A) may also have Workload B (122) with an associated MTP B (124), where Workload B (122) is executing in Virtual Machine (117C). Further, Node B (114B) may have Workload C (126) with an associated MTP C (128), where Workload C (126) is executing in Virtual Machine (117B). Additionally, Node B (114B) may also have Workload D (130) with an associated MTP D (132), where Workload D (130) is executing in Virtual Machine (117D).

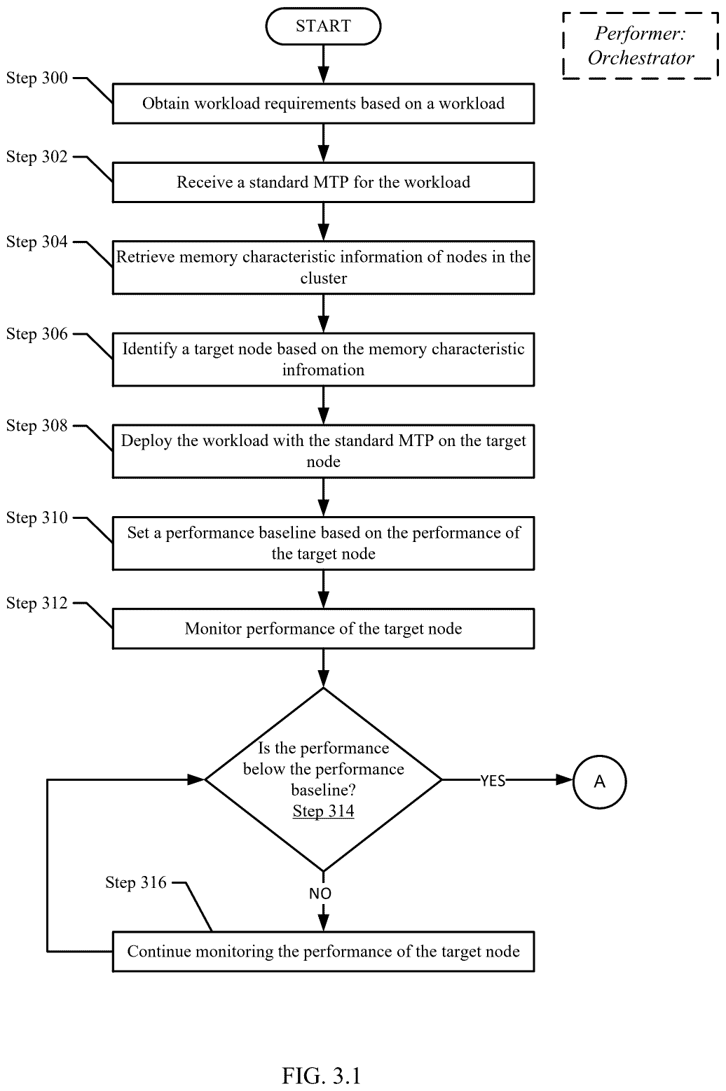

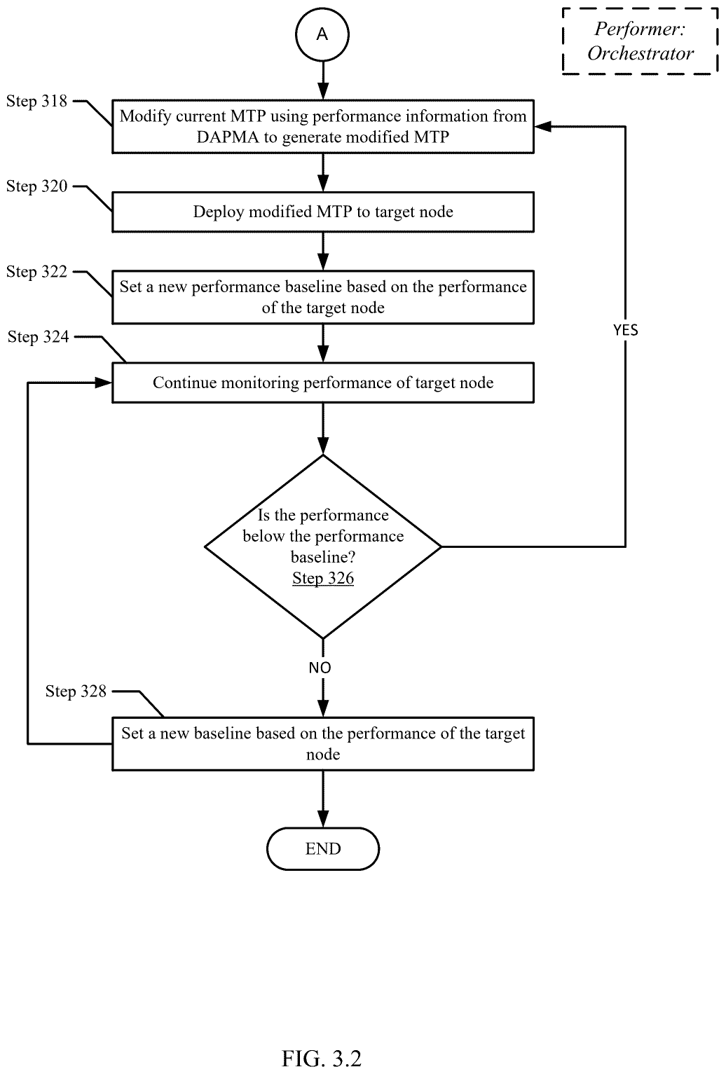

In one or more embodiments, the client(s) (100) and the orchestrator (102) may be operatively connected. In one or more embodiments, the client(s) (100) includes functionality to permit users to interact with the orchestrator. Further, the client(s) (100) includes functionality to perform at least a portion of the method shown in FIG. 3.1. One of ordinary skill will appreciate that the client(s) may perform other functionalities without departing from the scope of the invention.

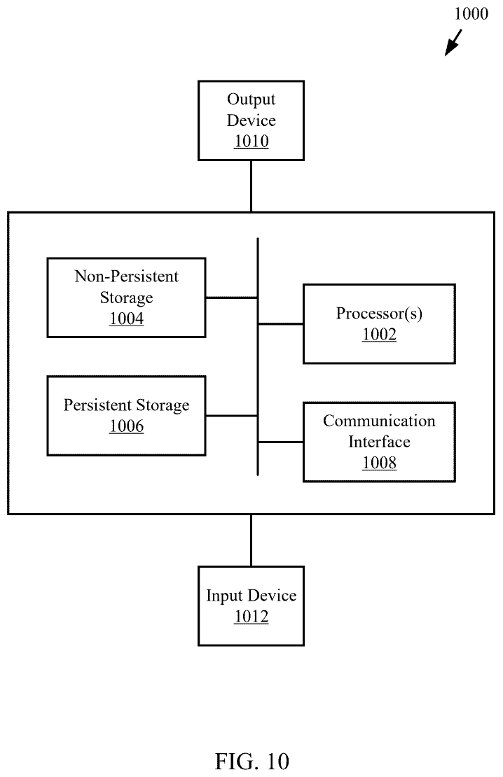

In one or more embodiments, the client(s) (100) may be a physical device or virtual device (i.e., a virtual machine executing on one or more physical devices) such as a personal computing system (e.g., a laptop, a cell phone, a tablet computer, a virtual machine executing on a server, etc.) of a user. For example, the client(s) (100) may be a computing system (e.g., 1000, FIG. 10) as discussed below in more detail in FIG. 10.

In one or more embodiments, the orchestrator (102) and the plurality of nodes (e.g. 114A-114B) may be operatively connected. In one or more embodiments, the orchestrator (102) includes functionality to generate standard MTPs by obtaining memory characteristic information of the cluster of nodes. In one or more embodiments, the orchestrator (102) also provides an option to the client to select from a list of standard MTPs to assign to a workload. In one or more embodiments, the orchestrator (102) also deploys workloads with an assigned MTP to an appropriate node in the cluster, and sets a performance baseline based on the performance information of that node with the assistance of the distributed app performance manager, or DAPM (104). If the performance of the node is below the performance baseline, the orchestrator (102) will modify the MTP accordingly, as discussed below in more detail in FIG. 3.2. In one or more embodiments, the orchestrator (102) may also assign the same MTP of a parent workload to the child workload(s).

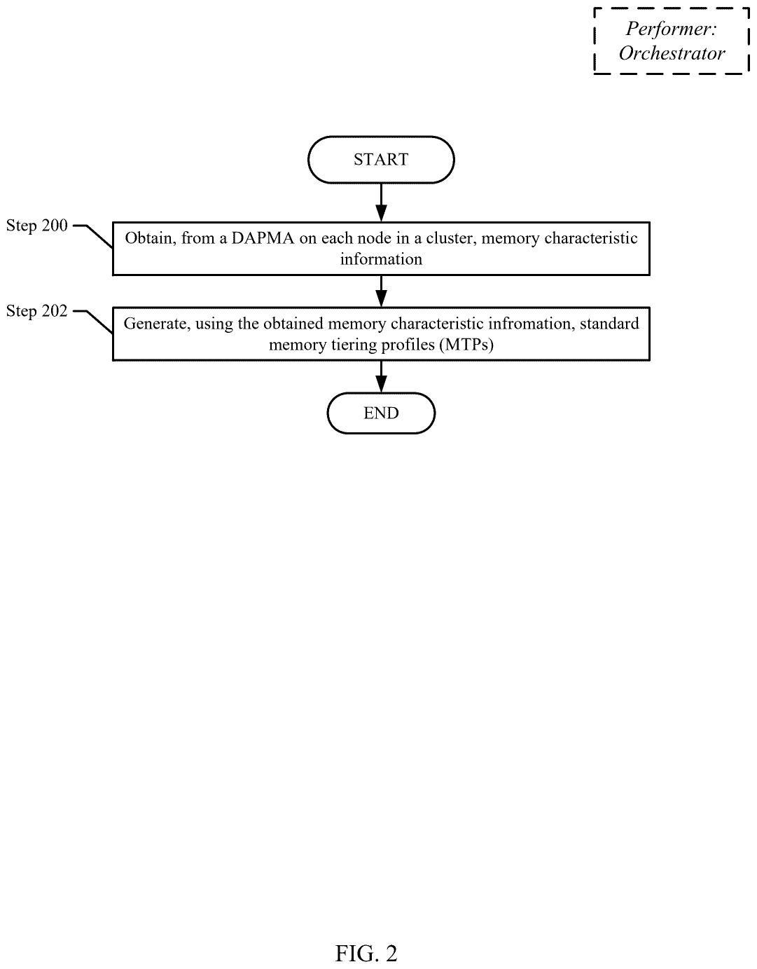

In one or more embodiments disclosed herein, the orchestrator (102) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the orchestrator (102) may be implemented on a computing system (e.g., 1000, FIG. 10) as discussed below in more detail in FIG. 10. Additional detail regarding one or more embodiments of the orchestrator are described in FIGS. 2-6.

In one or more embodiments, the orchestrator (102) includes a distributed app performance manager (104), an operating system (106), and a hardware layer (108). The hardware layer (108) may further include a basic input/output system, or BIOS (110), and platform hardware (112). Each component of the orchestrator is discussed below.

In one or more embodiments, the distributed app performance manager, or DAPM, (104) includes functionality to determine where to deploy a workload with an associated MTP to an appropriate node. In one or more embodiments, the DAPM (104) takes properties of the associated MTP into consideration when determining an appropriate node on which to deploy the workload. In one or more embodiments, the DAPM (104) also includes functionality to assign parent and child workloads with associated MTPs to appropriate root nodes (RN) and distributed nodes (DN). In one or more embodiments, the DAPM (104) may set a performance baseline for the node based on the performance and reliability properties of the memory devices in the node on which the workload is running on. In one or more embodiments, the DAPM (104) may extract information from Advanced Configuration and Power Interface (ACPI) tables, Heterogeneous Memory Attribute Tables (HMAT), Memory Power State Tables (MPST), and Static Resource Affinity Tables (SRAT) to calculate and compare the performance and reliability of the memory devices in the cluster. In one or more embodiments, the DAPM (104) may also include functionality to assign the same MTP of the parent workload to all applicable child workloads, ensuring a standardized memory tiering performance across the cluster. In one or more embodiments, the DAPM (104) will use the MTP associated with the workloads to perform and manage various operations. These include virtual machine (VM) migration, non-uniform memory access (NUMA) within a host, node failures, and further distribution of workloads.

In one or more embodiments, the operating system, or OS (106) may refer to a computer program that may execute on the underlying hardware of the orchestrator (102). Specifically, the OS (106) may be designed and configured to oversee orchestrator (102) operations. To that extent, the OS (106) may include functionality to, for example, support fundamental orchestrator (102) functions; schedule tasks; mediate interactivity between logical (e.g., software) and physical (e.g., hardware) orchestrator (102) components; allocate orchestrator (102) resources; and execute or invoke other computer programs executing on the orchestrator (102). One or ordinary skill will appreciate that the OS (106) may perform other functionalities without departing from the scope of the invention.

The orchestrator (102) may include additional hardware elements (not shown). In one or more embodiments, the hardware layer (108) may include, but is not limited to, graphic cards, specialty processors, security modules, and any other hardware that a particular application of the orchestrator (102) needs. Other devices and modules may be included in the orchestrator (102) without departing from the invention. In one or more embodiments, the hardware layer further includes a basic input/output system, or BIOS (110) and platform hardware (112).

In one or more embodiments, the BIOS (110) may be firmware used to provide runtime services for the OS (106) and programs operating on the orchestrator (102). In one or more embodiments, the BIOS (110) may also test each of the hardware components of the orchestrator (102). The BIOS (110) also facilitates/loads the OS (106). The BIOS (110) may take other forms or may be associated with other components such as one or more remote access controllers (RAC) and/or baseboard management controller (BMC).

In one or more embodiments, the plurality of nodes (e.g., 114A-114B) include functionality to perform services for users of the nodes. The services may include any type of computer-implemented services without departing from the invention. The services and/or portions of services include, for example, generating inferences, training for machine learning, implementing in-memory databases, performing classification, data analysis, etc. Each node of the plurality of nodes may perform similar and/or different services. A single node (e.g., 114A) may not include the functionality to perform all portions of the service, and therefore, may use other nodes (e.g., 114B) to perform the portions of the service that the single node (e.g., 114A) is unable to perform.

In one or more embodiments, a memory tiering profile, or MTP (e.g., MTP A, MTP B, MTP C, and MTP D) includes functionality to manage memory placement on systems with multiple types of memory. In one or more embodiments, an MTP may specify a plurality of tiers, with different memory types assigned to each tier depending on the workload requirements. In a non-limiting example, a workload for machine learning (ML), which is memory and performance intensive, may have an MTP associated it in which the first tier is high bandwidth memory (HBM), the second tier is double data rate (DDR) memory, and the third tier is compute express link (CXL) connected memory. Similarly, another workload that is more memory intensive may have an MTP associated it in which the first tier is cache memory, the second tier is DDR memory, and the third tier is CXL connected memory. Other memory types that may be assigned include, but are not limited to, main memory, non-volatile memory (NVM), disaggregated memory, solid state drive (SSD), and hard disk drive (HDD).

Turning to FIG. 2, FIG. 2 shows a flowchart of a method for generating standard memory MTPs in accordance with one or more embodiments of the invention. The method may be performed by, for example, the orchestrator (102, FIG. 1). Other components in the system may perform this method without departing from the invention.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, an orchestrator (e.g., orchestrator (102) in FIG. 1) obtains memory characteristic information from a DAPMA (e.g., DAPMA (116A-116B) in FIG. 1) on each node in a cluster. In one or more embodiments, the DAPMA (116A-116B) obtains the memory characteristic information of the node from the ACPI, HMAT, MPST, and/or SRAT tables.

In step 202, the orchestrator (e.g., orchestrator (102) in FIG. 1) generates standard memory tiering profiles using the obtained memory characteristic information. In one or more embodiments, standard memory tiering profiles are profiles with fixed parameters. The method may end following step 202.

Turning to FIG. 3.1, FIG. 3.1 shows a flowchart of a method for deploying workloads with a standard MTP to a target node in accordance with one or more embodiments of the invention. The method may be performed by, for example, the orchestrator (102, FIG. 1). Other components in the system may perform this method without departing from the invention.

While the various steps in the flowchart shown in FIG. 3.1 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, workload requirements are obtained based on a workload. In one or more embodiments, the orchestrator (e.g., orchestrator (102) in FIG. 1) may obtain the workload requirements through the DAPM (e.g., DAPM (104) in FIG. 1).

In step 302, a standard MTP is received for the workload. In one or more embodiments, the standard MTP is selected by a user via a client.

In step 304, memory characteristic information of the nodes in the cluster are retrieved. In one or more embodiments, the memory characteristic information of the nodes may be collected from various ACPI tables by a DAMPA (e.g., the DAPMA (116A-116B) in FIG. 1).

In step 306, a target node is identified based on the memory characteristic information. In one or more embodiments, the target node resembles a node that a workload and associated MTP may be deployed on to perform efficiently. In one or more embodiments, the target node may initially meet the workload requirements (e.g., the target node can support the memory tiering specified in the standard MTP).

In step 308, the workload with the standard MTP is deployed on the target node. In one or more embodiments, the orchestrator (e.g., orchestrator (102) in FIG. 1) deploys the workload with the standard MTP on the target node through the DAPM (e.g. the DAPM (104) in FIG. 1). In one or more embodiments, a container or virtual machine (e.g., Virtual Machine (117A) in FIG. 1) executes the workload. Additionally, the standard MTP is associated with the virtual machine (e.g., Virtual Machine (117A) in FIG. 1) or container in which the workload is being executed.

In step 310, a performance baseline is set based on the performance of the target node. In one or more embodiments, the orchestrator (e.g., orchestrator (102) in FIG. 1) sets the performance baseline by obtaining performance information of the target node from the DAPM (e.g. the DAPM (104) in FIG. 1). The performance information includes performance metrics, where each of the performance metrics may correspond to the use of the various compute and memory resources on the target node prior to the execution of the workload. Examples of performance metrics may include, but are not limited to, the amount of utilization of each of the various compute and memory resources during execution of the workload. In one or more embodiments, the orchestrator (e.g., orchestrator (102) in FIG. 1) records a performance metric corresponding to the initial performance of the target node, and sets a performance baseline based on the performance metric.

In step 312, the orchestrator (e.g., orchestrator (102) in FIG. 1) monitors the performance of the target node as it executes the workload. In one or more embodiments, the orchestrator continuously receives performance information of the target node from the DAPM (e.g., the DAPM (104) in FIG. 1).

In step 314, the orchestrator (e.g., orchestrator (102) in FIG. 1) makes a determination as to whether the performance of the target node is below the performance baseline. Accordingly, in one or more embodiments, if the result of this determination is YES, the method proceeds to FIG. 3.2. If the result of the determination is NO, the method may proceed to step 316.

In step 316, the orchestrator (e.g., orchestrator (102) in FIG. 1) continues to monitor the performance of the target node.

Turning to FIG. 3.2, FIG. 3.2 shows a flowchart of a method for modifying an MTP associated with a workload and target node in accordance with one or more embodiments of the invention. The method may be performed by, for example, the orchestrator (102, FIG. 1).

While the various steps in the flowchart shown in FIG. 3.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 318, the current MTP is modified using performance information from the DAPMA (e.g., the DAPMA (116A-116B) in FIG. 1) to generate a modified MTP. In one or more embodiments, the modified MTP meets the workload requirements of the workload. Additionally, the modified MTP may also meet the memory requirements of the target node.

In step 320, the modified MTP is deployed to the target node. In one or more embodiments, the orchestrator (e.g., orchestrator (102) in FIG. 1) deploys the modified MTP on the target node through the DAPM (e.g. the DAPM (104) in FIG. 1).

In step 322, a new performance baseline is set based on the performance of the target node. In one or more embodiments, the orchestrator (e.g., orchestrator (102) in FIG. 1) sets the new performance baseline by obtaining performance information of the target node from the DAPM (e.g. the DAPM (104) in FIG. 1) based on the prior execution of the workload using the standard MTP. In one or more embodiments, the orchestrator (e.g., orchestrator (102) in FIG. 1) records a performance metric corresponding to the performance of the target node, and sets a performance baseline based on the performance metric.

In step 324, the orchestrator (e.g., orchestrator (102) in FIG. 1) continues to monitor the performance of the target node.

In step 326, the orchestrator (e.g., orchestrator (102) in FIG. 1) makes a determination as to whether the performance of the target node is below the performance baseline. Accordingly, in one or more embodiments, if the result of this determination is YES, the method proceeds back to step 318. Alternatively, if the result of the determination is NO, the method may proceed to step 328.

In step 328, a new baseline is set based on the performance of the target node. The new baseline is based on the performance of the target node that is implementing the workload using the modified MTP. In this manner, the baseline of the target node is increased.

The method may end following step 328.

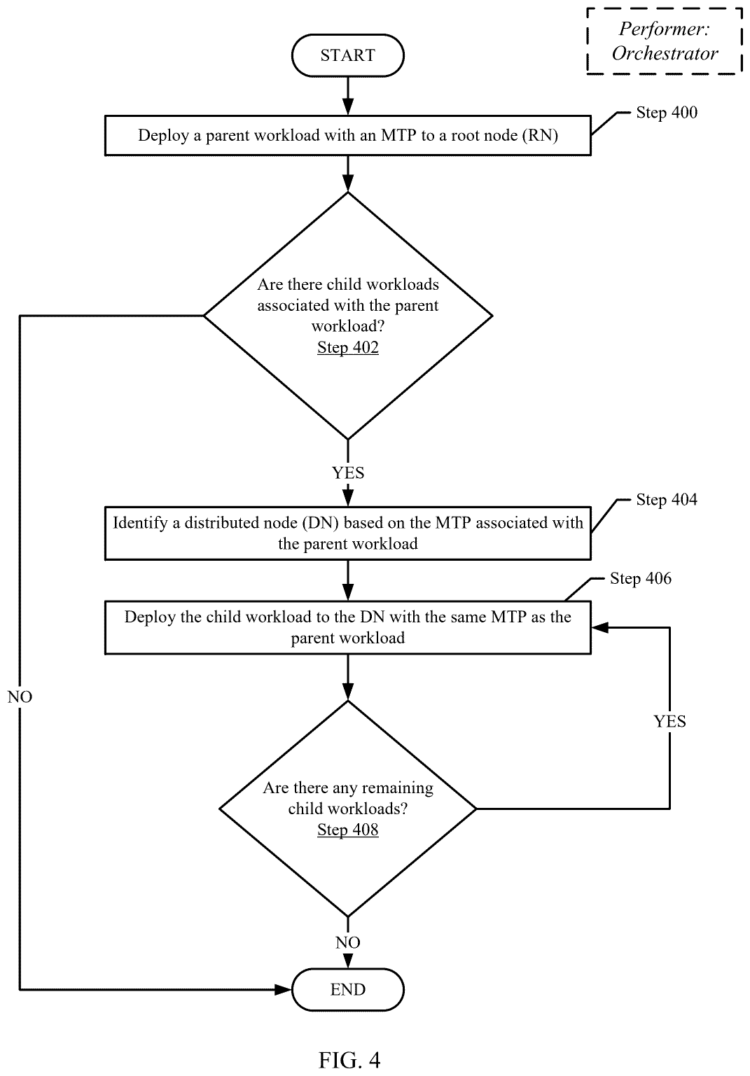

Turning to FIG. 4, FIG. 4 shows a flowchart of a method for assigning the same MTP of a parent workload to all child workloads in accordance with one or more embodiments of the invention. The method may be performed by, for example, the orchestrator (102, FIG. 1). Other components in the system may perform this method without departing from the invention.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

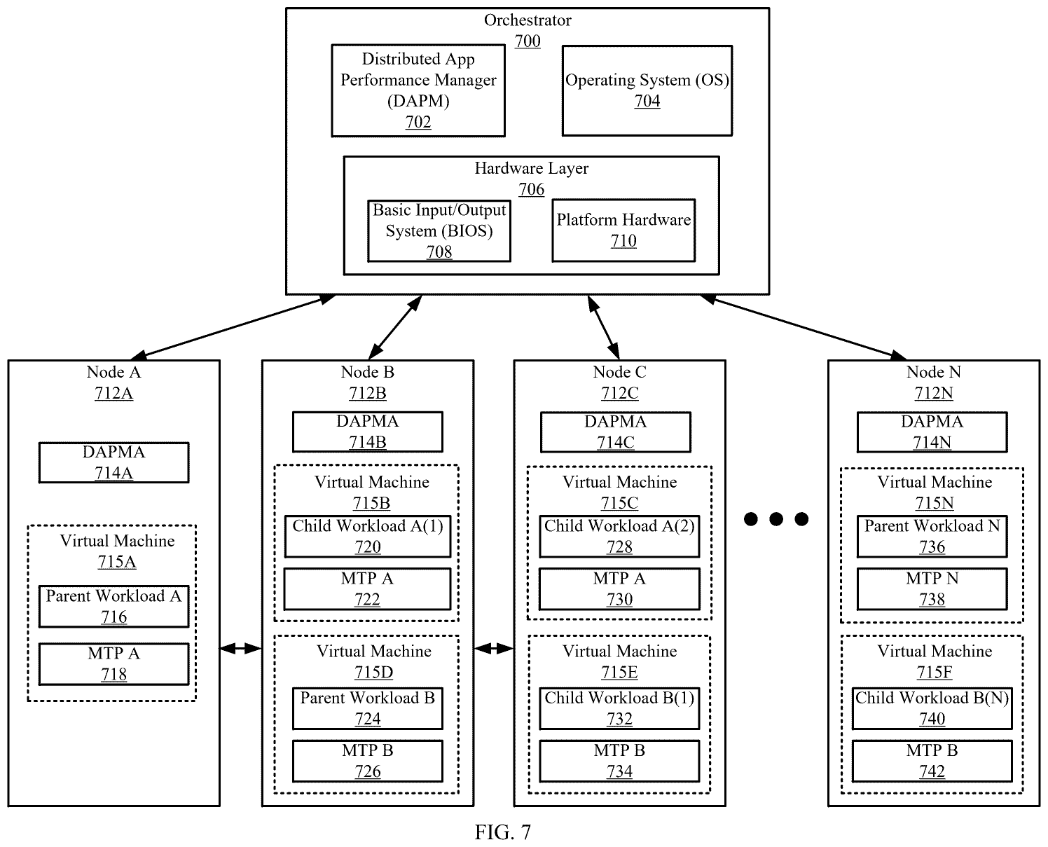

In step 400, a parent workload with an MTP is deployed to a root node (RN). In one or more embodiments, the orchestrator (e.g., orchestrator (700) in FIG. 7) deploys the parent workload with the MTP on the RN through the DAPM (e.g. the DAPM (702) in FIG. 7). The deployment of the parent workload and the MTP to the RN may be performed in accordance with FIG. 3.1-3.2.

In step 402, the orchestrator (e.g., orchestrator (700) in FIG. 7) makes a determination as to whether there are child workloads associated with the parent workload. Accordingly, in one or more embodiments, if the result of this determination is YES, the method proceeds to step 404. If the result of the determination is NO, the method may end following step 402.

In step 404, a distributed node (DN) is identified based on the MTP associated with the parent workload. In one or more embodiments, the orchestrator (e.g., orchestrator (700) in FIG. 7) identifies a DN by determining the memory requirements associated with the DN and using the properties of the MTP.

In step 406, the child workload is deployed to the DN with the same MTP as the parent workload. In one or more embodiments, the orchestrator (e.g., orchestrator (700) in FIG. 7) deploys the workload with the standard MTP on the target node through the DAPM (e.g. the DAPM (702) in FIG. 7). The deployment of the child workload and the MTP to the DN may be performed in accordance with FIG. 3.1-3.2.

In step 408, the orchestrator (e.g., orchestrator (700) in FIG. 7) makes a determination as to whether there are any remaining child workloads. Accordingly, in one or more embodiments, if the result of this determination is YES, the method proceeds back to step 406. Alternatively, if the result of the determination is NO, the method may end following step 408.

When the MTP is modified on the RN (per FIG. 3.1-3.2), the modified MTP is also loaded on to the DNs executing the child workloads, such that all associated workloads are executing using the same MTP.

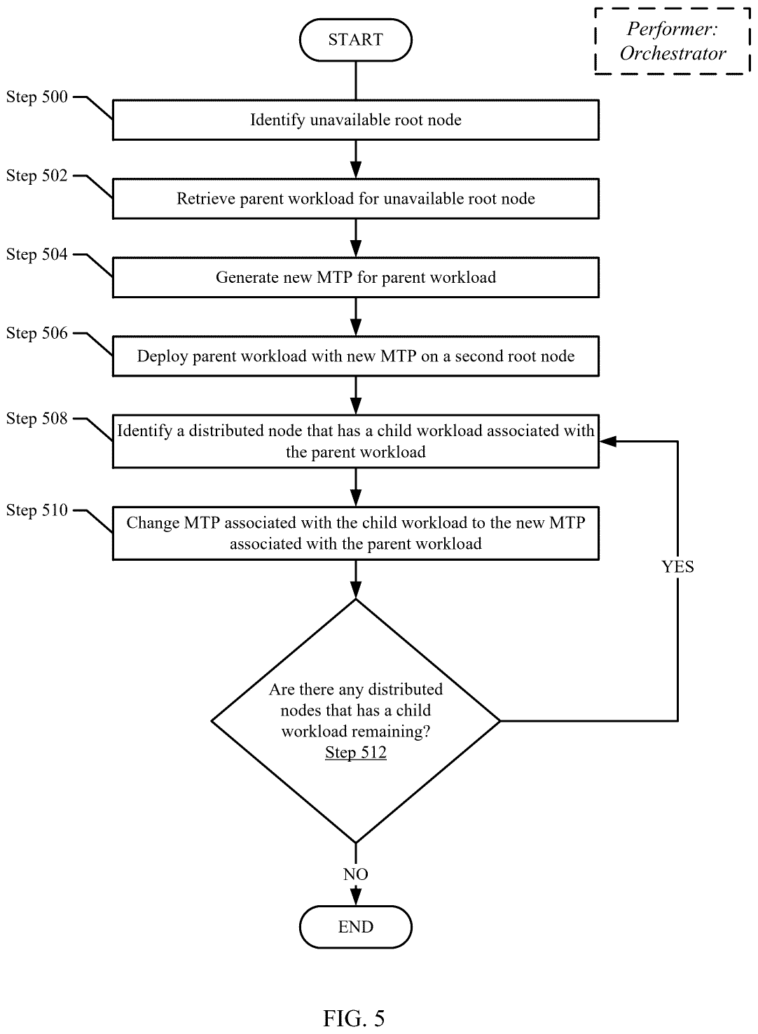

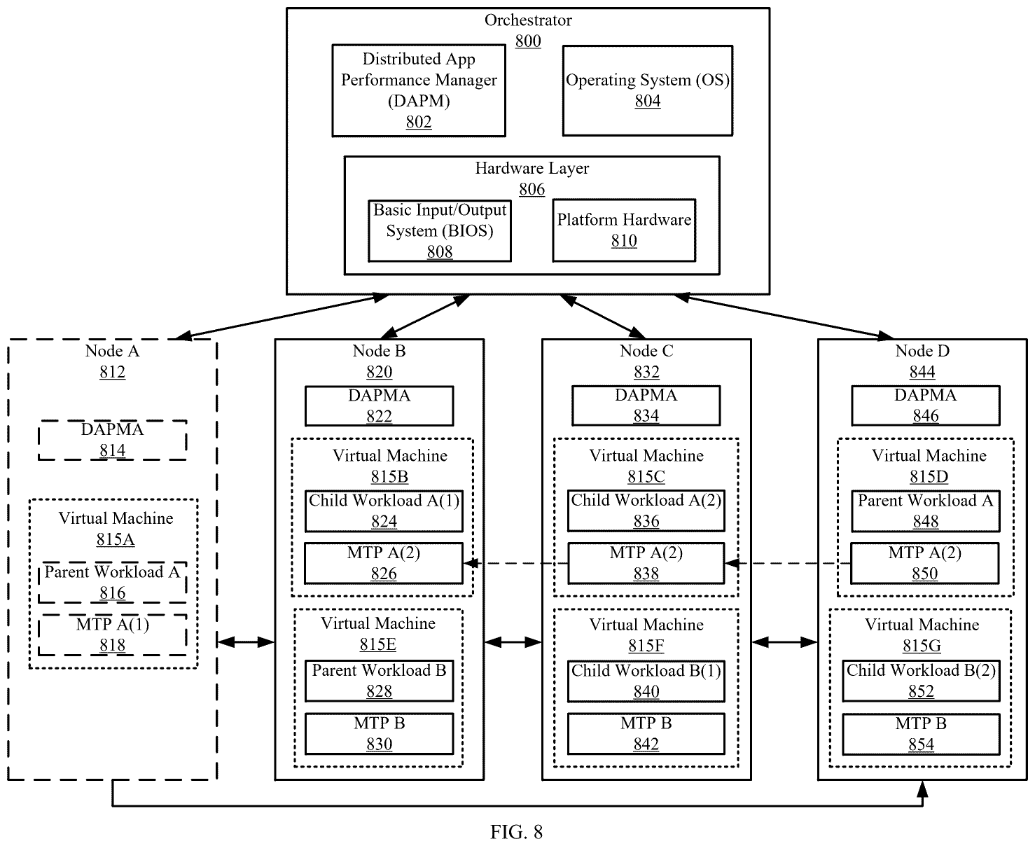

Turning to FIG. 5, FIG. 5 shows a flowchart of a method for deploying a parent workload from an unavailable root node to a second root node in accordance with one or more embodiments of the invention. The method may be performed by, for example, the orchestrator (800, FIG. 8).

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 500, an unavailable root node (RN) is identified. In one or more embodiments, the unavailable RN is identified by the orchestrator (e.g., orchestrator (800) in FIG. 8). In one or more embodiments, the RN may have become unavailable, for example, when it goes offline for maintenance or when it goes offline for failing (e.g., the root node crashes).

In step 502, the parent workload is retrieved for the unavailable root node. In one or more embodiments, the orchestrator (e.g., orchestrator (800) in FIG. 8) retrieves the parent workload through the DAPM (e.g. DAPM (802) in FIG. 8).

In step 504, a new MTP is generated for the parent workload. In one or more embodiments, the new MTP meets the parent workload requirements of the workload but also takes into account the memory resources of the available nodes in the cluster.

In step 506, the parent workload with the new MTP is deployed on a second root node (RN). In one or more embodiments, the orchestrator (e.g., orchestrator (800) in FIG. 8) deploys the new MTP on the second root node through the DAPM (e.g. the DAPM (802) in FIG. 8).

In step 508, a distributed node (DN) that has a child workload associated with the parent workload is identified. In one or more embodiments, the child workload is currently associated with the previous MTP that the parent workload was associated with on the unavailable node.

In step 510, the MTP associated with the child workload is changed to the new MTP associated with the parent workload.

In step 512, the orchestrator (e.g., orchestrator (102) in FIG. 1) makes a determination as to whether there are any distributed nodes that has a child workload remaining. Accordingly, in one or more embodiments, if the result of this determination is YES, the method proceeds back to step 508. Alternatively, if the result of the determination is NO, the method may end following step 512.

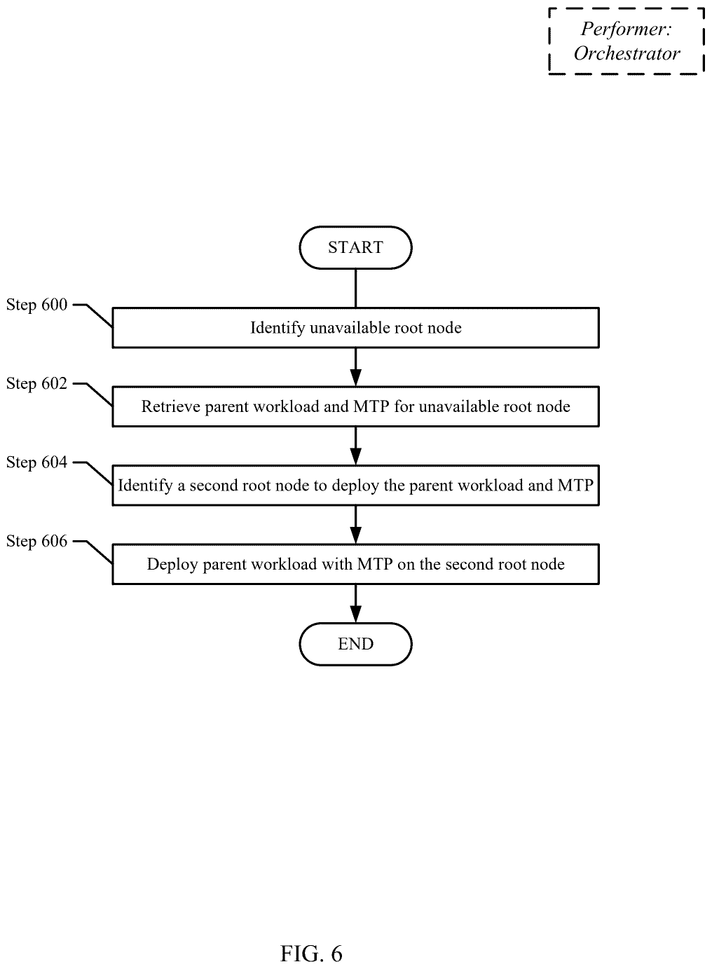

Turning to FIG. 6, FIG. 6 shows a flowchart of a method for deploying a parent workload from an unavailable root node to a second root node in accordance with one or more embodiments of the invention. The method may be performed by, for example, the orchestrator (102, FIG. 1).

While the various steps in the flowchart shown in FIG. 6 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

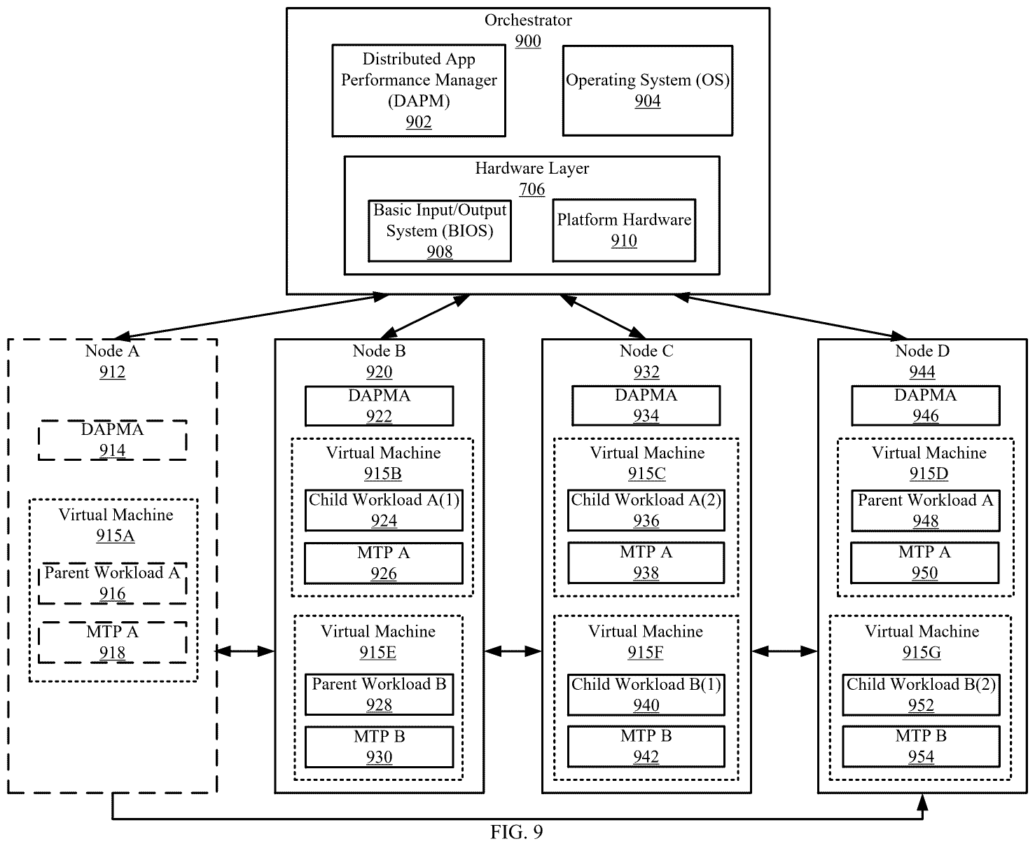

In step 600, an unavailable root node is identified. In one or more embodiments, the unavailable RN is identified by the orchestrator (e.g., orchestrator (900) in FIG. 9). In one or more embodiments, the RN may have become unavailable by becoming offline (e.g., the node is taken offline for maintenance).

In step 602, a parent workload and MTP is retrieved for the unavailable root node. In one or more embodiments, the orchestrator (e.g., orchestrator (900) in FIG. 9) retrieves the parent workload through the DAPM (e.g. DAPM (902) in FIG. 9).

In step 604, a second root node is identified to deploy the parent workload and MTP. In one or more embodiments, the orchestrator (e.g., orchestrator (900) in FIG. 9) identifies the second root node based on the parent workload requirements and the properties of the associated MTP.

In step 606, the parent workload with the MTP is deployed on the second root node. In one or more embodiments, the orchestrator (e.g., orchestrator (900) in FIG. 9) deploys the parent workload and the MTP on the second root node through the DAPM (e.g. the DAPM (902) in FIG. 9).

In one or more embodiments, the method may end following step 606.

The following section describes various non-limiting examples of various embodiments of the invention. The examples are not intended to limit the scope of the invention.

Turning to FIG. 7, FIG. 7 shows a diagram of a parent and child workload system in accordance with one or more embodiments of the invention. The system includes an orchestrator (700) and a plurality of nodes (e.g., 712A-712N) that communicate through an internal network or by other means. Each component is operatively connected to any of the other components via any combination of wired and/or wireless connections.

In this example, the orchestrator (700), in accordance with FIG. 4, assigns the same MTP of a parent workload to the child workload(s). This ensures uniform performance across the nodes in the cluster. More specifically, Node A (712A) has Parent Workload A (716) with an associated MTP A (718). Further, Node B (712B) has Child Workload A(1) (720), which is the first spawn of Parent Workload A (716), with an associated MTP A (722). In other words, Child Workload A(1) (720) will have the same MTP as Parent Workload A (716). Node B (712B) may also have another parent workload, Parent Workload B (724), with an associated MTP B (726). Further, Node C (712C) has Child Workload A(2) (728), which is the second spawn of Parent Workload A (716), with an associated MTP A (730). In other words, Child Workload A(2) (728) will have the same MTP as Parent Workload A (716). Node C may also have another child workload, Child Workload B(1) (732), which is the first spawn of Parent Workload B (724), with an associated MTP B (734). In other words, Child Workload B(1) (732) will have the same MTP as Parent Workload B (724). Finally, Node N has Parent Workload N (736) with an associated MTP N (738). Node N may also have another spawn of Parent Workload B (724), Child Workload B(N) (740), that will have an associated MTP B (742). In other words, Child Workload B(N) (740) will have the same MTP as Parent Workload B (724).

In one or more embodiments, the parent and child workload system (e.g., FIG. 7) ensures all child workloads spawned from a parent workload will have the same MTP as the parent workload. This achieves uniform performance across the nodes in which the distributed processes (i.e., child workloads) are running.

Turning to FIG. 8, FIG. 8 shows a diagram of a parent and child workload system with an unavailable node in accordance with one or more embodiments of the invention. The system may include an orchestrator (800) and a plurality of nodes. In this example, the system includes four nodes (Node A (812), Node B (820), Node C (832), and Node D (844)) that may communicate through an internal network or by other means.

In this example, Node A (812) becomes an unavailable node. Parent Workload A (816), which had been previously deployed on Node A (812), is retrieved by the orchestrator (800) and deployed onto Node D (844). In this example, Node D is the second root node identified by the orchestrator (800), as discussed above in FIG. 5. A new MTP, labeled MTP A(2) (850), is generated for Parent Workload A (816) in Node A and is also deployed onto Node D (844). The orchestrator (800) identifies all distributed nodes in which the child workloads of Parent Workload A (848) are deployed. In this example, Node B and Node C are distributed nodes. The orchestrator (800) will then change the MTPs associated with the child workloads to the new MTP associated with Parent Workload A (848). In this example, Child Workload A(1), which is the first spawn of Parent Workload A (848), on Node B (820), will now be associated with MTP A(2) (826). Similarly, Child Workload A(2) (836), which is the second spawn of Parent Workload A (848), will now be associated with MTP A(2) (838).

In one or more embodiments, the system represented in FIG. 8 ensures all child workloads continue to have the same MTP as their parent workload. Specifically, the system demonstrates that when a new MTP must be generated for a parent workload, the orchestrator will ensure all child workloads'MTPs have changed to the new MTP of the parent workload. This achieves uniform performance across the nodes in which the distributed processes (i.e., child workloads) are running.

Turning to FIG. 9, FIG. 9 shows a diagram of a parent and child workload system with an unavailable node in accordance with one or more embodiments of the invention. The system may include an orchestrator (900) and a plurality of nodes. In this example, the system includes four nodes (e.g., Node A (912), Node B (920), Node C (932), and Node D (944)) that communicate through an internal network or by other means.

In this example, Node A (912) becomes an unavailable node. Parent Workload A (916), which had been previously deployed on Node A (912), is retrieved by the orchestrator (900) along with the associated MTP A (918). The orchestrator (900) will then deploy it onto Node D (944). In this example, Node D is the second root node identified by the orchestrator (900), as discussed above in FIG. 6.

In one or more embodiments, the system represented in FIG. 9 ensures all child workloads continue to have the same MTP as their parent workload. Specifically, the system demonstrates that when a root node becomes unavailable, the parent workload along with its associated MTP may be deployed onto a second root node. This ensures the parent workload and its child workloads have the same MTP, achieving uniform performance across the nodes in which distributed processes (i.e., child workloads) are running.

Embodiments of the disclosure may be implemented using computing devices. FIG. 10 shows a diagram of a computing device (1000) in accordance with one or more embodiments. The computing device (1000) may include one or more computer processors (1002), non-persistent storage (1004) (e.g., volatile memory, such as random access memory (RAM), cache memory), persistent storage (1006) (e.g., a hard disk, an optical drive such as a compact disk (CD) drive or digital versatile disk (DVD) drive, a flash memory, etc.), a communication interface (1008) (e.g., Bluetooth interface, infrared interface, network interface, optical interface, etc.), input devices (1012), output devices (1010), and numerous other elements (not shown) and functionalities. Each of these components is described below.

In one embodiment, the computer processor(s) (1002) may be an integrated circuit for processing instructions. For example, the computer processor(s) (1002) may be one or more cores or micro-cores of a processor. The computing device (1000) may also include one or more input devices (1012), such as a touchscreen, keyboard, mouse, microphone, touchpad, electronic pen, or any other type of input device. The communication interface (1008) may include an integrated circuit for connecting the computing device (1000) to a network (not shown) (e.g., a local area network (LAN), a wide area network (WAN) such as the Internet, mobile network, or any other type of network) and/or to another device, such as another computing device.

In one embodiment, the computing device (1000) may include one or more output devices (1010), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (1012, 1010) may be locally or remotely connected to the computer processor(s) (702), non-persistent storage (1004), and persistent storage (1006). Many diverse types of computing devices exist, and the aforementioned input and output device(s) (1012, 1010) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the prior description of the figures, any component described with regard to a figure, in various embodiments of the invention, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for generating a dynamic memory tiering profile (MTP) for a workload, the method comprising:
obtaining workload requirements based on the workload;
receiving a standard MTP for the workload;
retrieving, from a distributed app performance manager agent (DAPMA), memory characteristic information of a plurality of nodes in a cluster;
identifying, based on the memory characteristic information, a target node;
deploying the workload with the standard MTP on the target node, wherein the workload is executing in a virtual machine (VM) on the target node, wherein the standard MTP is associated with the VM;
measuring a first performance metric of the target node;
setting a first performance baseline based on the first performance metric of the target node;
monitoring a performance of the target node;
making a determination that the performance of the target node is below the performance baseline; and
modifying, using the performance of the target node, the standard MTP to generate a dynamic MTP.

2. The method of claim 1, wherein the memory characteristic information is collected from various Advanced Configuration and Power Interface (ACPI) tables.

3. The method of claim 1, the method further comprising:
deploying the dynamic MTP to the target node;
measuring a second performance metric of the target node;
setting a second performance baseline based on the second performance metric of the target node;
monitoring the performance of the target node;
making a second determination that the second performance of the target node is below the second performance baseline; and
modifying, using the second performance of the target node, the dynamic MTP to generate a second dynamic MTP.

4. The method of claim 3, wherein the second performance of the target node is above the second performance baseline, the method further comprises:
measuring a third performance metric of the target node;
setting a third performance baseline based on the third performance metric of the target node; and
monitoring the performance of the target node.

5. The method of claim 1, wherein the workload is a parent workload, the method further comprises:
deploying the parent workload with an associated MTP to a root node (RN);
making a third determination that there are a plurality of child workloads associated with the parent workload;
identifying, based on the associated MTP, a distributed node (DN); and
deploying a child workload of the plurality of child workloads and the associated MTP to the DN.

6. The method of claim 5, the method further comprising:
identifying an unavailable RN;
retrieving the parent workload and the associated MTP for the unavailable RN;
identifying a second RN to deploy the parent workload and associated MTP; and
deploying the parent workload with the associated MTP on the second RN.

7. The method of claim 5, the method further comprising:
identifying an unavailable RN;
retrieving the parent workload and the associated MTP for the unavailable RN;
generating a second associated MTP for the parent workload; and
deploying the parent workload and the second associated MTP on a second RN.

8. The method of claim 7, wherein after deploying the parent workload and the second associated MTP on a second RN, the method further comprises:
identifying the DN that has a child workload associated with the parent workload; and
changing the associated MTP of the child workload to the second associated MTP.

9. A non-transitory computer readable medium (CRM) comprising computer readable program code, which when executed by a computer processor, enables the computer to perform a method for generating a dynamic memory tiering profile (MTP) for a workload, the method comprising:
obtaining workload requirements based on the workload;
receiving a standard MTP for the workload;
retrieving, from a distributed app performance manager agent (DAPMA), memory characteristic information of a plurality of nodes in a cluster;
identifying, based on the memory characteristic information, a target node;
deploying the workload with the standard MTP on the target node, wherein the workload is executing in a virtual machine (VM) on the target node, wherein the standard MTP is associated with the VM;
measuring a first performance metric of the target node;
setting a first performance baseline based on the first performance metric of the target node;
monitoring a performance of the target node;
making a determination that the performance of the target node is below the performance baseline; and
modifying, using the performance of the target node, the standard MTP to generate a dynamic MTP.

10. The non-transitory CRM of claim 9, wherein the memory characteristic information is collected from various Advance Configuration and Power Interface (ACPI) tables.

11. The non-transitory CRM of claim 9, the method further comprising:
deploying the dynamic MTP to the target node;
measuring a second performance metric of the target node;
setting a second performance baseline based on the second performance metric of the target node;
monitoring the performance of the target node;
making a second determination that the second performance of the target node is below the second performance baseline; and
modifying, using the second performance of the target node, the dynamic MTP to generate a second dynamic MTP.

12. The non-transitory CRM of claim 11, wherein the second performance of the target node is above the second performance baseline, the method further comprises:
measuring a third performance metric of the target node;
setting a third performance baseline based on the third performance metric of the target node; and
monitoring the performance of the target node.

13. The non-transitory CRM of claim 9, wherein the workload is a parent workload, the method further comprises:
deploying the parent workload with an associated MTP to a root node (RN);
making a third determination that there are a plurality of child workloads associated with the parent workload;
identifying, based on the associated MTP, a distributed node (DN); and
deploying a child workload of the plurality of child workloads and the associated MTP to the DN.

14. The non-transitory CRM of claim 13, the method further comprising:
identifying an unavailable RN;
retrieving the parent workload and the associated MTP for the unavailable RN;
identifying a second RN to deploy the parent workload and associated MTP; and
deploying the parent workload with the associated MTP on the second RN.

15. The non-transitory CRM of claim 13, the method further comprising:
identifying an unavailable RN;
retrieving the parent workload and the associated MTP for the unavailable RN;
generating a second associated MTP for the parent workload; and
deploying the parent workload and the second associated MTP on a second RN.

16. The non-transitory CRM of claim 15, wherein after deploying the parent workload and the second associated MTP on a second RN, the method further comprises:
identifying the DN that has a child workload associated with the parent workload; and
changing the associated MTP of the child workload to the second associated MTP.

17. A system, the system comprising:
an orchestrator;
a cluster of nodes;
at least one processor; and
at least one memory that includes instructions, which when executed by the processor, performs a method for generating a dynamic memory tiering profile (MTP) for a workload, the method comprising:
obtaining workload requirements based on the workload;
receiving a standard MTP for the workload;
retrieving, from a distributed app performance manager agent (DAPMA), memory characteristic information of a plurality of nodes in a cluster;
identifying, based on the memory characteristic information, a target node;
deploying the workload with the standard MTP on the target node, wherein the workload is executing in a virtual machine (VM) on the target node, wherein the standard MTP is associated with the VM;
measuring a first performance metric of the target node;
setting a first performance baseline based on the first performance metric of the target node;
monitoring a performance of the target node;
making a determination that the performance of the target node is below the performance baseline; and
modifying, using the performance of the target node, the standard MTP to generate a dynamic MTP.

18. The system of claim 17, wherein the memory characteristic information is collected from various Advanced Configuration and Power Interface (ACPI) tables.

19. The system of claim 17, wherein the standard MTP is generated by the orchestrator.

20. The system of claim 17, wherein the workload is a parent workload, the method further comprises:
deploying the parent workload with an associated MTP to a root node (RN);
making a second determination that there are a plurality of child workloads associated with the parent workload;
identifying, based on the associated MTP, a distributed node (DN); and
deploying a child workload of the plurality of child workloads and the associated MTP to the DN.
